(19) United States
(12) Patent Application Publication
(10) Pub. No.: US 2024/0192354 A1
(43) Pub. Date: Jun. 13, 2024

(54) SYSTEMS AND METHODS FOR FORMING AND DISPLAYING AN ANALYTE LOCATION MAP

(71) Applicant: TELEDYNE FLIR DETECTION, INC., Stillwater, OK (US)

(72) Inventors: Kemper Talley, Oak Ridge, TN (US); Jeremy P. Walker, Pittsburgh, PA (US)

(21) Appl. No.: 18/532,202

(22) Filed: Dec. 7, 2023

Related U.S. Application Data
(60) Provisional application No. 63/386,382, filed on Dec. 7, 2022.

(51) Int. Cl. G01S 13/72; G01S 13/86; G02B 27/01

(52) U.S. Cl. CPC G01S 13/72; G01S 13/865; G01S 13/867; G02B 27/017

(57) ABSTRACT

Systems and methods for forming and displaying an analyte location map is provided. The system includes a detector, a display device, and a controller. The detector is configured to measure concentration of an analyte and output a signal based on the measured concentration of the analyte. The controller includes a first location module, a second location module, a mapping module, and a presentation module. The mapping module is configured to generate 3D data of an area, generate analyte location data based on the signal from the detector and tracked 3D location of the detector, and combine the 3D data and the analyte location data to form an analyte location map. The presentation module is configured to display the analyte location map on the display device based on the tracked 3D location of the display device.

### CROSS-REFERENCE TO RELATED APPLICATIONS

This application claims priority to U.S. Provisional Patent Application No. 63/386,382, which was filed on Dec. 7, 2022, the contents of which is hereby incorporated by reference into this specification.

### FIELD OF USE

The present disclosure relates to systems and methods for forming and displaying an analyte location map.

### BACKGROUND

Many threats to a user, such as, for example, radiation, can be undetectable by human senses. Accurately informing a user of an invisible threat present challenges.

### SUMMARY

One non-limiting aspect of the present disclosure is directed to a system comprising a detector, a display device, and a controller. The detector is configured to measure concentration of an analyte and output a signal based on the measured concentration of the analyte. The controller comprises a first location module, a second location module, a mapping module, and a presentation module. The first location module is configured to track a three-dimensional (3D) location of the detector. The second location module is configured to track a 3D location and an orientation of the display device. The mapping module is configured to generate 3D data of an area, generate analyte location data based on the signal from the detector and tracked 3D location of the detector, and combine the 3D data and the analyte location data to form an analyte location map. The presentation module is configured to display the analyte location map on the display device based on the tracked 3D location of the display device.

Another non-limiting aspect of the present disclosure is directed to a system comprising a virtual detector, a display device, and a controller. The virtual detector is configured to generate analyte location data based on placement of a virtual threat source. The controller comprises a location module, a mapping module, and a presentation module. The location module is configured to track a three-dimensional (3D) location and an orientation of the display device. The mapping module is configured to generate 3D data of an area and combine the 3D data and the analyte location data to form an analyte location map. The presentation module is configured to display the analyte location map on the display device based on the tracked location of the display device.

It will be understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The features and advantages of the examples presented herein, and the manner of attaining them, will become more apparent, and the examples will be better understood, by reference to the following description taken in conjunction with the accompanying drawings, wherein:

FIG. 1 is a schematic diagram of a non-limiting embodiment of a system for forming and displaying an analyte concentration map according to the present disclosure;

FIG. 2 is a schematic diagram of a non-limiting embodiment of a system for forming and displaying an analyte concentration map according to the present disclosure;

FIG. 3 is an image of a non-limiting embodiment of a portion of an analyte location map according to the present disclosure;

FIG. 4 is an image of a non-limiting embodiment of a portion of an analyte location map according to the present disclosure;

FIG. 5 is an image of a non-limiting embodiment of a portion of an analyte location map according to the present disclosure;

FIG. 6 is an image of a non-limiting embodiment of a portion of a signal from a detector according to the present disclosure;

FIG. 7 is an image of a non-limiting embodiment of a portion of 2D digital representation of locations of analyte from the perspective of the detector according to the present disclosure;

FIG. 8 is an image of a non-limiting embodiment of a portion of a signal from a detector according to the present disclosure;

FIG. 9 is an image of a non-limiting embodiment of a portion of an analyte location map according to the present disclosure; and

FIG. 10 is an image of a non-limiting embodiment of a portion of a signal from a detector shown on the right and a portion of an analyte location map created therefrom shown on the left.

The exemplifications set out herein illustrate certain non-limiting embodiments, in one form, and such exemplifications are not to be construed as limiting the scope of the appended claims and the invention in any manner.

### DETAILED DESCRIPTION OF NON-LIMITING EMBODIMENTS

Various examples are described and illustrated herein to provide an overall understanding of the structure, function, and use of the disclosed systems, apparatus, and methods. The various examples described and illustrated herein are non-limiting and non-exhaustive. Thus, the invention is not limited by the description of the various non-limiting and non-exhaustive examples disclosed herein. Features and characteristics illustrated and/or described in connection with various examples herein may be combined with features and characteristics of other examples herein. Such modifications and variations are intended to be included within the scope of the present disclosure. The various non-limiting embodiments disclosed and described in the present disclosure can comprise, consist of, or consist essentially of the features and characteristics as variously described herein.

Any references herein to “various non-limiting embodiments”, “some non-limiting embodiments”, “certain non-limiting embodiments”, “one non-limiting embodiment”, “a non-limiting embodiment”, “an embodiment”, “one embodiment”, or like phrases mean that a particular feature, structure, act, or characteristic described in connection with the example is included in at least one embodiment. Thus, appearances of the phrases “various non-limiting embodiments”, “some non-limiting embodiments”, “certain non-limiting embodiments”, “one non-limiting embodiment”, “a non-limiting embodiment”, “an embodiment”, “one embodiment”, or like phrases in the specification do not necessarily refer to the same non-limiting embodiment. Furthermore, the particular described features, structures, or characteristics may be combined in any suitable manner in one or more non-limiting embodiments. Thus, the particular features, structures, or characteristics illustrated or described in connection with one non-limiting embodiment may be combined, in whole or in part, with the features, structures, or characteristics of one or more other non-limiting embodiments without limitation. Such modifications and variations are intended to be included within the scope of the present non-limiting embodiments.

As used herein, “at least one of” a list of elements means one of the elements or any combination of two or more of the listed elements. As an example “at least one of A, B, and C” means A only; B only; C only; A and B; A and C; B and C; or A, B, and C.

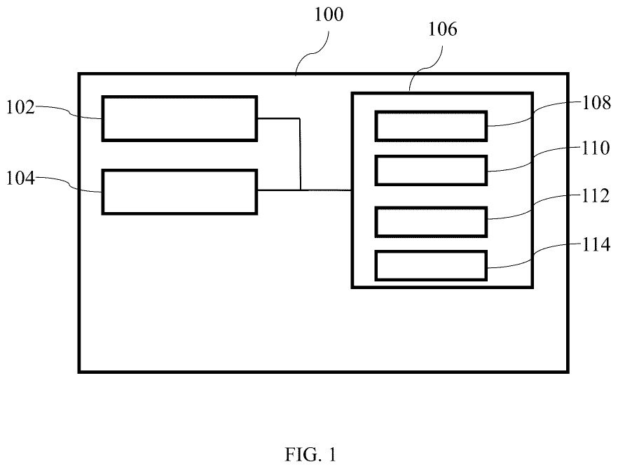

Referring to FIG. 1, a schematic diagram of a system 100 is provided. The system 100 comprises a detector 102, a display device 104, and a controller 106 in signal communication with the detector 102 and the display device 104. The detector 102, the display device 104, and the controller 106 can be a part of the same device, or part of different devices distributed across a network. For example, a first device can comprise the detector 102, a second device can comprise the display device 104, and the controller 106 can be on the first device, the second device, or a third device. For example, the first, second, and third devices can be in wired or wireless communication. For example, the wireless communication can comprise at least one of a near field communication (NFC), Bluetooth, a Wi-Fi (e.g., 800 MHZ), and ZigBee.

The detector 102 can be configured to measure a concentration of an analyte and output a signal based on the measured concentration of the analyte. The analyte can comprise at least one of a chemical agent, a biological agent, radiological material, and nuclear material. For example, in various embodiments the analyte comprises a chemical that can comprise a chemical warfare agent (e.g., a nerve agent, a blister agent), a narcotic (e.g., fentanyl, heroin, methamphetamine), an explosive (e.g., a peroxide, a nitroglyceride, rdx), a toxic industrial chemical, and a toxic industrial material. In various embodiments the analyte comprises a radiological material and/or a nuclear material that can comprise at least one of gamma radiation, beta radiation, and alpha radiation. The detector 102 can comprise devices suitable to determine the presence of the analyte and/or determine a concentration of the analyte, such as, for example, at least one of an ion mobility spectrometer, a mass spectrometer, a RAMAN spectroscopic device, a radiation detector, an electrochemical sensor, a chemosensor array, a photochemical sensor, and a camera (e.g., 2D). In various non-limiting embodiments, the analyte comprises radiological material and the detector comprises a radiation detector based upon a scintillation material and presence of a silicon photomultiplier. For example, the detector 102 can comprise a TELEDYNE FLIR R425 identiFINDER® sensor apparatus.

The display device 104 can be in wired communication and/or wireless communication with the controller 106 and/or the detector 102. For example, the wireless communication can comprise at least one of NFC, Bluetooth, a Wi-Fi, and ZigBee. For example, the display device 104 can be in Bluetooth communication with at least one of the controller 106 and the detector 102. The display device 104 can comprise various hardware components suitable to present an augmented reality image and/or a virtual reality image to a user. In various non-limiting embodiments, the display device 104 comprises at least one of an augmented reality display device and a virtual reality display device. For example, the display device 104 can comprise a heads-up display, such as, for example, a heads-up display on a windshield, eyeglasses, a visor, or the like.

The controller 106 can be configured to control the functions of the system 100. For example, as used herein, the term “controller” may refer to at least one of hardwired circuitry, programmable circuitry (e.g., a computer processor comprising one or more individual instruction processing cores, processing unit, processor, microcontroller, microcontroller unit, controller, digital signal processor (DSP), programmable logic device (PLD), programmable logic array (PLA), or FPGA), state machine circuitry, and firmware that stores instructions executed by programmable circuitry. The controller 106 may be collectively or individually embodied as circuitry that forms part of a larger system, for example, an IC, an ASIC, a SoC, desktop computers, laptop computers, tablet computers, servers, smart phones, etc. Accordingly, as used herein, “controller” includes, but is not limited to, electrical circuitry having at least one discrete electrical circuit, electrical circuitry having at least one IC, electrical circuitry having at least one application-specific IC, electrical circuitry forming a general-purpose computing device configured by a computer program (e.g., a general-purpose computer configured by a computer program that at least partially carries out processes and/or devices described herein, or a microprocessor configured by a computer program that at least partially carries out processes and/or devices described herein), electrical circuitry forming a memory device (e.g., forms of RAM), and/or electrical circuitry forming a communications device (e.g., a modem, communications switch, or optical-electrical equipment).

The controller 106 can comprise a first location module 108, a second location module 110, a mapping module 112, and a presentation module 114. As used herein, the term “module” and the like can refer to a computer-related entity such as, for example, hardware, a combination of hardware and software, software, or software in execution. For example, the “module” can comprise an app, software, firmware, and/or circuitry configured to perform any of the operations described herein. Software may be embodied as a software package, code, instructions, instruction sets, and/or data recorded on a non-transitory computer-readable storage medium. Firmware may be embodied as code, instructions or instruction sets, and/or data that are hard-coded (e.g., nonvolatile) in memory devices. The controller 106 can be included in, for example, at least one of the display device 104, the detector 102, and a secondary device.

The first location module 108 can be configured to track a three-dimensional (3D) location of the detector 102. For example, the first location module 108 can comprise a 3D camera, a radio detection and ranging (RADAR) system, a light detection and ranging (LIDAR) system, and a global positioning system (GPS). The first location module 108 can determine a 3D location of the detector 102 in an area and correlate the 3D location of the detector to the output signal of the detector 102 to the 3D location in the area. In various non-limiting embodiments, the first location module 108 comprises GPS and is embedded in the detector 102 and/or the first location module 108 comprises a 3D camera and is embedded in the display device 104.

The second location module 110 can be configured to track a 3D location and an orientation of the display device 104. For example, the second location module 110 can comprise a 3D camera, a RADAR system, a LIDAR system, and a GPS. For example, when the display device 104 comprises an augmented reality display device, the second location module 110 can determine the field of view of a user of the area based on the 3D location and orientation of the display device such that the field of view can be correlated to the portion of an analyte location map to be presented to the user. In various non-limiting embodiments, the first location module 108 and the second location module 110 are the same and both comprise a 3D camera that is embedded in the display device 104.

The mapping module 112 can be configured to generate 3D data of an area (e.g., room, field, site). The 3D data can be a spatial mesh of the area or other 3D location data, such as, for example, a point cloud. The 3D data of the area can be initially provided to the mapping module 112 and the mapping module 112 can update the 3D data with analyte data or the mapping module 112 can generate the 3D data on its own without being provided an initial mapping. The mapping module 112 can be supported by the first location module 108 and/or the second location module 110.

The mapping module 112 can generate analyte location data based on the signal from the detector 102 and tracked 3D location of the detector 102 from the first location module 108. For example, the mapping module 112 can correlate that the 3D location of the detector 102 to a concentration measurement in the signal output by the detector 102. The mapping module 112 can combine the 3D data and the analyte location data (e.g., currently detected analyte location data, previously detected analyte location data) to form an analyte location map. For example, the mapping module 112 can form a spatial mesh of analyte concentrations received from the detector 102 based on a location of the detector 102 when the measurement was taken within the area determined by the first location module 108.

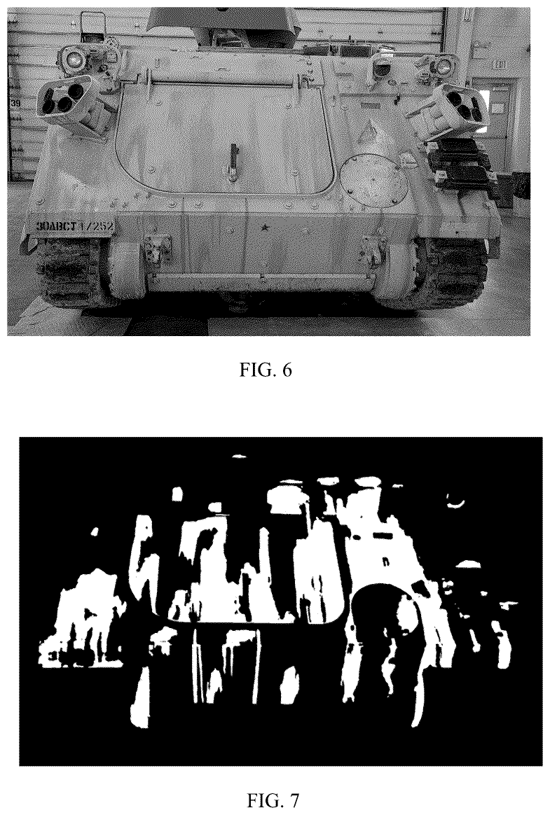

In embodiments where the detector 102 comprises a camera, the detector 102 can output 2 dimensional data (2D) signal (e.g., an image) and the detector 102, in combination with the controller 106, can utilize deep learning techniques, such as, for example, a neural network to determine the presence of the analyte and/or determine a concentration of the analyte based on the 2D data. In certain non-limiting embodiments, the controller 106 can determine the presence of analyte in the signal output from the detector 102 as shown in FIG. 6 utilizing a colorimetric response and/or an intensity response. The analyte can be observable or machine visible on its own and/or one or more chemical indicators can be applied to a surface to enhance the analyte detection, such as those described in U.S. Pat. No. 10,730,083, which is hereby incorporated by reference. The controller 106 can transform the image of FIG. 6 output by the detector 102 into a 2D digital representation of locations of analyte from the perspective of the detector 102 as shown in FIG. 7. As illustrated in FIG. 7, white pixels in FIG. 7 illustrate detected analyte and black pixels represent where no analyte was detected. The mapping module 112 can generate analyte location data based on the 2D digital representation and tracked 3D location of the detector 102 from the first location module 108.

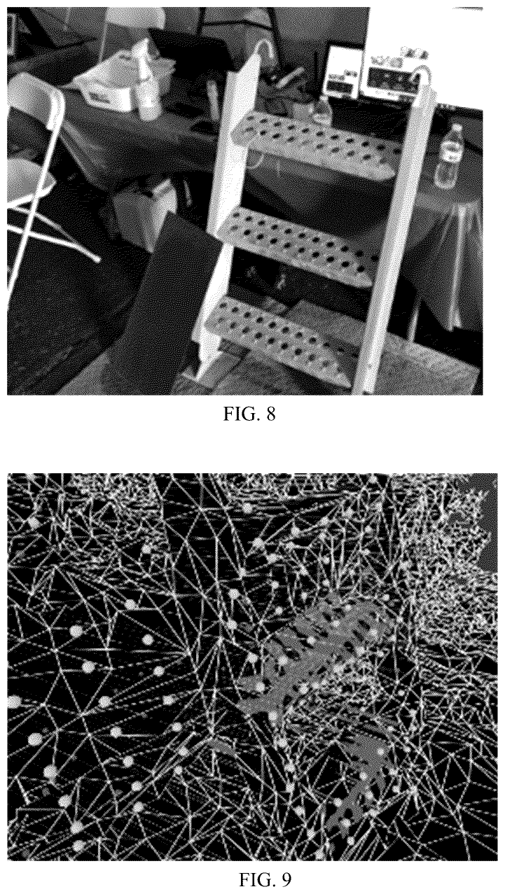

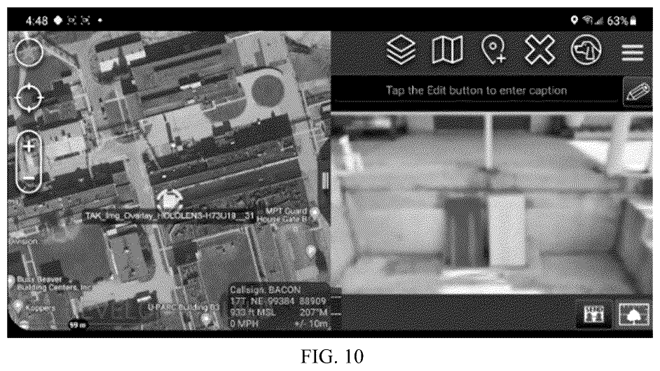

In certain non-limiting embodiments, the mapping module 112 can align a 2D signal from the detector 102 with a spatial mesh created by the mapping module 112 and wrap the 2D signal output from the detector to a spatial mesh formed by the mapping module 112 to form the analyte location map (e.g., a 3D representation of detected analyate). In various non-limiting embodiments, the mapping module 112 can utilize GPS, a field of view of the detector 102, and/or a pose of the detector 102 to form the analyze location map. For example, as illustrated in FIG. 8, an image was captured by a detector 102 and the presence of the analyte was detected. The presence of the analyte was aligned and wrapped onto a spatial mesh formed by the mapping module 112 to form an analyate location map as shown in FIG. 9. As illustrated in FIG. 9, pink was used to mark the location of the analyte.

In various non-limiting embodiments, the mapping module 112 can be configured to generate a predicted analyte location data based on the analyte location data. For example, the mapping module 112 can predict concentrations of the analyte in portions of the area where a measurement of the analyte was not performed by the detector 102 by using an algorithm, a weather pattern, or other function based on the measurement of concentrations of the analyte by the detector 102 in other portions of the area.

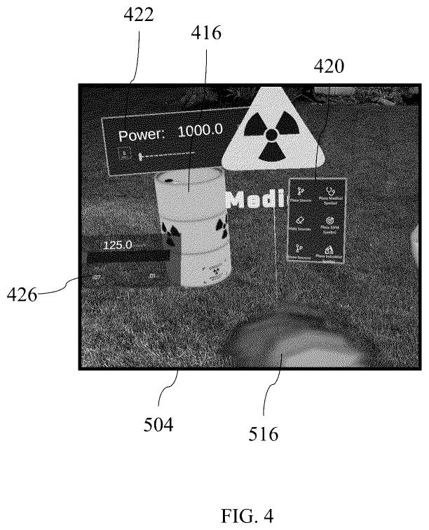

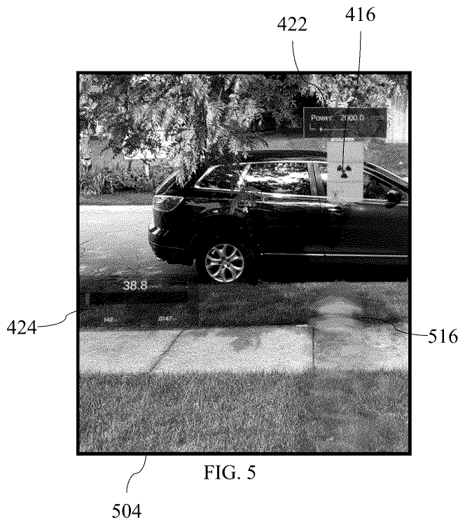

The presentation module 114 can be configured to display the analyte location map on the display device 104 based on the tracked 3D location of the display device 104 from the second location module 110. The analyte location map can indicate a concentration of the analyte using, for example, at least one of a color of an indicator and a height of an indicator. For example, referring to FIG. 4, an analyte location map 416 is shown on a display device 404 and referring to FIG. 5, an analyte location map 516 is shown on a display device 504. In various non-limiting embodiments, referring to FIGS. 4 and 5, the analyte location map 416 and the location map 516 are heat maps based on a concentration gradient of the analyte measured by the detector 102. Referring to FIG. 4, the analyte location map 416 comprises varying colors to illustrate the concentration of the analyte as a function of location. Referring to FIG. 5, the analyte location map 516 comprises varying colors of indicators and varying heights of indicators to illustrate the concentration of the analyte as a function of location. In various non-limiting embodiments, the presentation module 114 can be configured to dynamically update the analyte location map 416 on the display device 402 based on the tracked location of the display device 404.

In various non-limiting embodiments, the presentation module 114 can be configured to display the analyte location map, which can comprise 3D data, onto the display device 104, which may be a 2D display (e.g., 2D real time video stream) or a 3D display. For example, the presentation module 114 can utilize augmented reality to overlay the analyte location map onto a real-time video generated on the display device 104. In certain non-limiting embodiments, the signal from the detector 102 shown on the right in FIG. 10 can be utilized to generate the analyte location map shown on the left in FIG. 10.

In certain non-limiting embodiments, referring to FIG. 4, when operating in a virtual test mode, the detector 102 is a virtual detector. The virtual detector can be configured to generate virtual analyte location data based on placement of a virtual threat source 418. The controller 106 can be configured to position the virtual threat source 418 in the 3D data. For example, the presentation module 112 can be configured to detect a hand gesture (e.g., palm up, a swipe, first) from a user and present a menu 420 to the user to select a virtual threat source configuration. The virtual threat source configuration can comprise threat type, threat power (e.g., concentration gradient), 3D location, time, and/or other threat parameter. In certain non-limiting embodiments, the presentation module 112 can be configured to change a display of the analyte location map 416 based on a hand gesture.

After placing the virtual threat source 416, referring to FIG. 1, the mapping module 112 can be configured to form a virtual analyte location map including a spatial mesh of virtual analyte concentrations based on the placement of the virtual threat source 416 in relation to the spatial mesh and predicted concentrations of the analyte based on the virtual threat source 416. The presentation module 114 can be configured to display the virtual analyte location map on the display device 104 based on the tracked 3D location of the display device 104 from the second location module 110.

The presentation module 112 can be configured to display various virtual threat source configuration parameters, such as, for example, threat power 422 and/or an analyte concentration 424 output by the detector 102 (calculated analyte concentration based on the virtual threat source 418 or an actual measurement output by the detector 102 which can be mirrored on the display device 404). When operating in the virtual test mode, the presentation module 112 can output analyte concentration data to the detector 102 to be displayed on the detector 102 based on the virtual analyte location map.

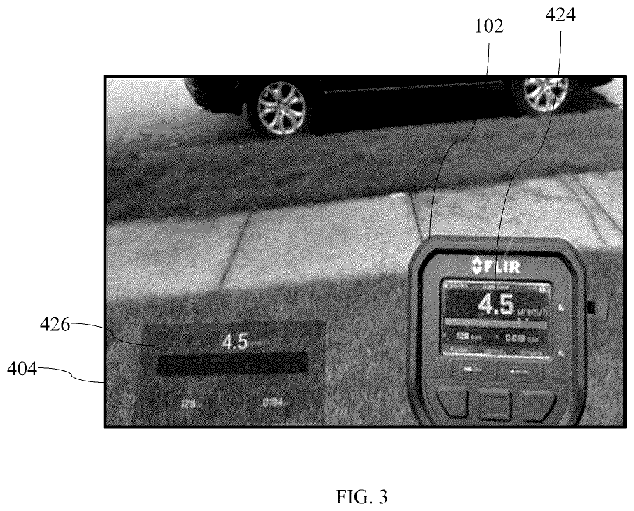

In various non-limiting embodiments, referring to FIG. 3, an analyte concentration 424 output by the detector 102 (real or virtual) can be mirrored on the display device 404 as a virtual element 426 and the first location module 112 can determine a 3D location of the detector 102 using a sensor (e.g., camera) embedded in the display device 404. The virtual threat source 418 can stay at the 3D location until the virtual threat source 418 is cleared by the user.

The system 100 can be used for real measurements of analyte concentrations and for training scenarios to train personnel on the operation of the system 100 or an element thereof (e.g., detector 102, display device 104).

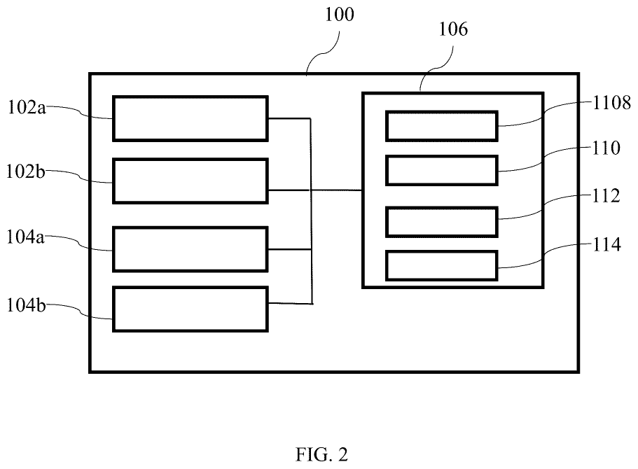

The system 100 can comprise various detectors and display devices in communication. For example, referring to FIG. 2, the controller 106 can be configured to generate analyte location data based on at least two signals output from at least two detectors 106a-106b and tracked locations of the at least two detectors 106a-106b. The presentation module 114 can be configured to display the analyte location map on at least two display devices 104a-104b based on tracked locations of the at least two display devices 104a-104b. The portion of the analyte location map on the at least two display devices 104a-104b can be the same or different depending if the location and orientation of the at least two display devices 104a-104b is the same or different.

The present disclosure can enable a real-time system that can measure analyte concentration from a plurality of different assets; network mobile components (e.g., operators, robots, unmanned aerial vehicles, unmanned ground vehicles) and stationary components (e.g., portals); display an analyte concentration map to multiple users; and predict analyte source location/type/amounts. Embodiments of the systems according to the present disclosure can also enable supervisory observation of users. Embodiments of the systems according to the present disclosure can enable visualization of various threats using detectors fused with augmented reality display devices.

Various aspects of non-limiting embodiments of an invention according to the present disclosure include, but are not limited to, the aspects listed in the following numbered clauses.

Clause 1. A system comprising:
a detector configured to measure a concentration of an analyte and output a signal based on the measured concentration of the analyte;
a display device; and
a controller comprising
   a first location module configured to track a three-dimensional (3D) location of the detector,
   a second location module configured to track a 3D location and an orientation of the display device,
   a mapping module configured to
      generate 3D data of an area,
      generate analyte location data based on the signal from the detector and tracked 3D location of the detector, and
      combine the 3D data and the analyte location data to form an analyte location map, and
   a presentation module configured to display the analyte location map on the display device based on the tracked 3D location of the display device.

Clause 2. The system of clause 1, wherein the analyte location map is a heat map based on a concentration gradient of the analyte measured by the detector.

Clause 3. The system of any of clauses 1-2, wherein the 3D data is a spatial mesh.

Clause 4. The system of any of clauses 1-3, wherein the mapping module is configured to generate a predicted analyte location data based on the analyte location data.

Clause 5. The system of any of clauses 1-4, wherein the analyte comprises at least one of a chemical, a biological agent, radiological material, and nuclear material.

Clause 6. The system of any of clauses 1-5, wherein the analyte comprises at least one of a chemical warfare agent, a narcotic, an explosive, a toxic industrial chemical, and a toxic industrial material.

Clause 7. The system of any of clauses 1-5, wherein the analyte comprises at least one of gamma radiation, beta radiation, and alpha radiation.

Clause 8. The system of any of clauses 1-7, wherein the detector comprises at least one of an ion mobility spectrometer, a mass spectrometer, a RAMAN spectroscopic device, a radiation detector, an electrochemical sensor, a chemosensor array, and a photochemical sensor.

Clause 9. The system of any of clauses 1-8, wherein the analyte comprises radiological material and the detector comprises a radiation detector based upon a scintillation material and presence of a silicon photomultiplier.

Clause 10. The system of any of clauses 1-9, wherein the display device comprises at least one of an augmented reality display device and a virtual reality display device.

Clause 11. The system of any of clauses 1-10, wherein the display device comprises a heads up display.

Clause 12. The system of any of clauses 1-11, wherein at least one of the first location module and the second location module comprises a 3D camera, a radio detection and ranging (RADAR) system, a light detection and ranging (LIDAR) system, and a global positioning system (GPS).

Clause 13. The system of any of clauses 1-12, wherein the presentation module is configured to dynamically update the display of the analyte location map on the display device based on the tracked location of the display device.

Clause 14. The system of any of clauses 1-13, wherein the controller is configured to generate analyte location data based on at least two signals from at least two detectors and tracked locations of the at least two detectors.

Clause 15. The system of any of clauses 1-14, wherein the presentation module is configured to display the analyte location map on at least two display devices based on tracked locations of the at least two display devices.

Clause 16. The system of any of clauses 1-15, wherein the controller is included in at least one of the display device, the detector, and a secondary device.

Clause 17. The system of any of clauses 1-16, wherein the display device is in at least one of wired communication and wireless communication with at least one of the controller and the detector.

Clause 18. The system of any of clauses 1-17, wherein the display device is in wireless communication with at least one of the controller and the detector, and the wireless communication comprises Bluetooth.

Clause 19. The system of any of clauses 1-18, wherein the presentation module is configured to change the display of the analyte location map based on a hand gesture.

Clause 20. The system of any of clauses 1-19, wherein the analyte location map indicates concentration of the analyte using at least one of a color of an indicator and a height of an indicator.

Clause 21. The system of any one of clauses 1-20, wherein the mapping modules is configured to combine the 3D data of and previous analyte location data to form a second analyte location map and wherein the presentation module is configured to display the second analyate location map on the display device based on the tracked location of the display device.

Clause 22. A system comprising:
a virtual detector configured to generate analyte location data based on placement of a virtual threat source;
a display device; and
a controller comprising
   a location module configured to track a three-dimensional (3D) location and an orientation of the display device,
   a mapping module configured to
      generate 3D data of an area, and
      combine the 3D data and the analyte location data to form an analyte location map, and
   a presentation module configured to display the analyte location map on the display device based on the tracked location of the display device.

Clause 23. The system of clause 22, wherein the controller is configured to position the virtual threat source in the 3D data.

Clause 24. A method for training a user of a detector comprising using the system of any of clauses 22-23.

Clause 25. A method of use of the system of any of clauses 1-23.

Clause 26. A method comprising:
measuring a concentration of an analyte utilizing a detector;
outputting, by the detector, a signal based on the measured concentration of the analyte;
determining, with a controller, a three-dimensional (3D) location of the detector while measuring the concentration of the analyte;
determining, with the controller, a 3D location and an orientation of a display device;
generating, with the controller, 3D data of an area;
generating, with a controller, analyte location data based on the signal from the detector and tracked 3D location of the detector;
combining, with the controller, the 3D data and the analyte location data to form an analyte location map; and
displaying the analyte location map on the display device based on the tracked 3D location of the display device.

In the present disclosure, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in the present disclosure is intended to include all higher numerical limitations subsumed therein. Accordingly, Applicant reserves the right to amend the present disclosure, including the claims, to expressly recite any sub-range subsumed within the ranges expressly recited. All such ranges are inherently described in the present disclosure.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

The foregoing detailed description has set forth various forms of the devices and/or processes via the use of block diagrams, flowcharts, and/or examples. Insofar as such block diagrams, flowcharts, and/or examples contain functions and/or operations, it will be understood by those skilled in the art that each function and/or operation within such block diagrams, flowcharts, and/or examples can be implemented, individually and/or collectively, by a wide range of hardware, software, firmware, or virtually any combination thereof. Those skilled in the art will recognize that some examples of the forms disclosed herein, in whole or in part, can be equivalently implemented in integrated circuits, as a computer program running on a computer (e.g., as a programs running on a computer system), as a program running on a processor (e.g., as a program running on a microprocessor), as firmware, or as virtually any combination thereof, and that designing the circuitry and/or writing the code for the software and or firmware would be well within the skill of one skilled in the art in light of this disclosure. In addition, those skilled in the art will appreciate that the mechanisms of the subject matter described herein are capable of being distributed as a program product in a variety of forms, and an illustrative form of the subject matter described herein applies regardless of the particular type of signal bearing medium used to actually carry out the distribution.

Instructions used to program logic to perform various disclosed examples can be stored within a memory in the system, such as dynamic random access memory (DRAM), cache, flash memory, or other storage. Furthermore, the instructions can be distributed via a network or by way of other computer-readable media. Thus a machine-readable medium may include any mechanism for storing or transmitting information in a form readable by a machine (e.g., a computer), including, but not limited to, floppy diskette, optical disk, compact disc read-only memory (CD-ROM), magneto-optical disk, read-only memory (ROM), random access memory (RAM), erasable programmable read-only memory (EPROM), electrically erasable programmable read-only memory (EEPROM), magnetic or optical card, flash memory, or a tangible, machine-readable storage used in the transmission of information over the Internet via electrical, optical, acoustical, or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

One skilled in the art will recognize that the herein described apparatus, systems, structures, methods, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A system comprising:
a detector configured to measure a concentration of an analyte and output a signal based on the measured concentration of the analyte;
a display device; and
a controller comprising
a first location module configured to track a three-dimensional (3D) location of the detector,
a second location module configured to track a 3D location and an orientation of the display device,
a mapping module configured to
generate 3D data of an area,
generate analyte location data based on the signal from the detector and tracked 3D location of the detector, and
combine the 3D data and the analyte location data to form an analyte location map, and
a presentation module configured to display the analyte location map on the display device based on the tracked 3D location of the display device.

2. The system of claim 1, wherein the analyte location map is a heat map based on a concentration gradient of the analyte measured by the detector.

3. The system of claim 1, wherein the 3D data is a spatial mesh.

4. The system of claim 1, wherein the mapping module is configured to generate a predicted analyte location data based on the analyte location data.

5. The system of claim 1, wherein the analyte comprises at least one of a chemical agent, a biological agent, radiological material, and nuclear material.

6. The system of claim 1, wherein the analyte comprises at least one of a chemical warfare agent, a narcotic, an explosive, a toxic industrial chemical, and a toxic industrial material.

7. The system of claim 1, wherein the analyte comprises at least one of gamma radiation, beta radiation, and alpha radiation.

8. The system of claim 1, wherein the detector comprises at least one of an ion mobility spectrometer, a mass spectrometer, a RAMAN spectroscopic device, a radiation detector, an electrochemical sensor, a chemosensor array, and a photochemical sensor.

9. The system of claim 1, wherein the analyte comprises radiological material and the detector comprises a radiation detector based upon a scintillation material and presence of a silicon photomultiplier.

10. The system of claim 1, wherein the display device comprises at least one of an augmented reality display device and a virtual reality display device.

11. The system of claim 1, wherein the display device comprises a heads up display.

12. The system of claim 1, wherein at least one of the first location module and the second location module comprises a 3D camera, a radio detection and ranging (RADAR) system, a light detection and ranging (LIDAR) system, and a global positioning system (GPS).

13. The system of claim 1, wherein the presentation module is configured to dynamically update the analyte location map on the display device based on the tracked location of the display device.

14. The system of claim 1, wherein the controller is configured to generate analyte location data based on at least two signals from at least two detectors and tracked locations of the at least two detectors.

15. The system of claim 1, wherein the presentation module is configured to display the analyte location map on at least two display devices based on tracked locations of the at least two display devices.

16. The system of claim 1, wherein the controller is included in at least one of the display device, the detector, and a secondary device.

17. The system of claim 1, wherein the display device is in at least one of wired communication and wireless communication with at least one of the controller and the detector.

18. The system of claim 1, wherein the display device is in wireless communication with at least one of the controller and the detector, and the wireless communication comprises Bluetooth.

19. The system of claim 1, wherein the presentation module is configured to change the analyte location map based on a hand gesture.

20. The system of claim 1, wherein the analyte location map indicates concentration of the analyte using at least one of a color of an indicator and a height of an indicator.

21. The system of claim 1, wherein the mapping modules is configured to combine the 3D data of and previous analyte location data to form a second analyte location map and wherein the presentation module is configured to display the second analyate location map on the display device based on the tracked location of the display device.

22. A system comprising:
a virtual detector configured to generate analyte location data based on placement of a virtual threat source;
a display device; and
a controller comprising
a location module configured to track a three-dimensional (3D) location and an orientation of the display device,
a mapping module configured to
generate 3D data of an area, and
combine the 3D data and the analyte location data to form an analyte location map, and
a presentation module configured to display the analyte location map on the display device based on the tracked location of the display device.

23. The system of claim 22, wherein the controller is configured to position the virtual threat source in the 3D data.

24. A method comprising
measuring a concentration of an analyte utilizing a detector;
outputting, by the detector, a signal based on the measured concentration of the analyte;
determining, with a controller, a three-dimensional (3D) location of the detector while measuring the concentration of the analyte;
determining, with the controller, a 3D location and an orientation of a display device;
generating, with the controller, 3D data of an area;
generating, with a controller, analyte location data based on the signal from the detector and tracked 3D location of the detector;
combining, with the controller, the 3D data and the analyte location data to form an analyte location map; and
displaying the analyte location map on the display device based on the tracked 3D location of the display device.
